(19) United States
(12) Patent Application Publication
(10) Pub. No.: US 2013/0247383 A1
(43) Pub. Date: Sep. 26, 2013

(54) HAND TOOL WITH REPLACEABLE KNIFE CARTRIDGE

(71) Applicants: Scott D. Gullicks, Woodbury, MN (US); Joy A. Packard, Somerset, WI (US); Michael C. Molinet, Stanford, CA (US); Gerald E. Mueller, Eagan, MN (US)

(72) Inventors: Scott D. Gullicks, Woodbury, MN (US); Joy A. Packard, Somerset, WI (US); Michael C. Molinet, Stanford, CA (US); Gerald E. Mueller, Eagan, MN (US)

(73) Assignee: 3M INNOVATIVE PROPERTIES COMPANY, St. Paul, MN (US)

(21) Appl. No.: 13/879,570

(22) PCT Filed: Jul. 18, 2011
(86) PCT No.: PCT/US2011/044338

§ 371 Date: Apr. 15, 2013

Related U.S. Application Data
(60) Provisional application No. 61/365,674, filed on Jul. 19, 2010.

(51) Int. Cl. B26B 29/06

(52) U.S. Cl. CPC B26B 29/06
USPC 30/162; 30/151

(57) ABSTRACT

A hand tool (100) including a replaceable knife cartridge (110) is disclosed herein. The body (120) of the hand tool operatively engages the knife cartridge such that the blade (111) of the cartridge is positioned for cutting packaging such as blister pack without damaging contents contained by the packaging.

### FIELD

This disclosure relates to hand tools for opening packages, and particularly to hand tools having replaceable knife cartridges.

### BACKGROUND

Blister pack is a type of packaging used for small consumer goods such as electronics, toys and hardware. One type of blister pack is the clamshell blister in which clear molded plastic sheeting is folded over onto itself to enclose the item(s) being packaged, and the sheeting is then fused at the edges. Other similar types of blister packs utilize two or more pieces of molded plastic sheeting to enclose the item(s). In general, blister packs are used extensively in industry for a variety of reasons, particularly because they are tamper resistant and deter package pilfering. Unfortunately, the average consumer can find it difficult to open this type of packaging. It is not uncommon for a consumer to inflict injury upon himself when opening a blister pack because sharp implements or inappropriate cutting tools are often employed.

### SUMMARY

A hand tool comprising a replaceable knife cartridge is disclosed herein. The body of the hand tool operatively engages the knife cartridge such that the blade of the cartridge is positioned for cutting packaging such as blister pack without damaging contents contained by the packaging.

The knife cartridge includes a cartridge housing and a blade, the cartridge housing having two opposing sides and a plurality of edges, at least one of the edges comprising a guide edge having a substantially planar surface, the cartridge housing holding the blade in a fixed position such that the blade partially protrudes from the guide edge. The hand tool includes a body comprising a grip portion, and an operative portion configured to hold the knife cartridge in a first position in which the knife cartridge is fully encased within the operative portion, and a second position in which the knife cartridge is partially encased within the operative portion such that the cutting edge of the blade protrudes from the operative portion of the body, and the guide edge of the knife cartridge engages with a surface of an item being cut.

These and other aspects of the invention are described in the detailed description below. In no event should the above summary be construed as a limitation on the claimed subject matter which is defined solely by the claims as set forth herein.

### BRIEF DESCRIPTION OF DRAWINGS

Advantages and features of the invention may be more completely understood by consideration of the following figures in connection with the detailed description provided below. The figures are schematic drawings of various articles and are not necessarily drawn to scale.

FIG. 1a shows a perspective view of an exemplary hand tool disclosed herein. FIGS. 1b-1d show side views of the exemplary hand tool shown in FIG. 1a, illustrating first, second and third positions, respectively, of the knife cartridge with respect to the body.

FIGS. 2a and 2b show side and edge views, respectively, of an exemplary knife cartridge disclosed herein.

FIGS. 3a and 3b show side views of the knife cartridge shown in FIGS. 2a and 2b, wherein the knife cartridge is used to cut sheeting.

FIG. 4 shows a side view of an exemplary hand tool disclosed herein, illustrating geometrical relationships between parts of the hand tool.

FIG. 5 shows a side view of an exemplary hand tool disclosed herein.

FIG. 6 shows a side view of an exemplary hand tool disclosed herein, illustrating a fourth position of the knife cartridge with respect to the body.

FIGS. 7a and 7b show side views of exemplary knife cartridges disclosed herein.

FIGS. 8a and 8b show engagement of a cartridge housing with a cartridge holder.

FIG. 9 shows an exploded perspective view of an exemplary hand tool disclosed herein.

FIG. 10 shows a tray holding a plurality of knife cartridges.

### DETAILED DESCRIPTION

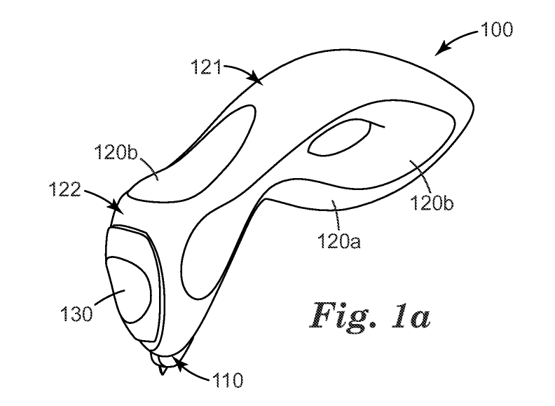

Referring to FIGS. 1a-1d, exemplary hand tool 100 comprises knife cartridge 110 and body 120. The body includes two portions: grip portion 121 for gripping the tool by hand and operative portion 122 for operating the knife cartridge as described further below. In some embodiments, one or more buttons, levers, knobs, or the like may be used in conjunction with the operative portion for engaging the knife cartridge. For the embodiment shown in FIGS. 1a-1d, button 130 is shown as a generic button, and it is to be understood that any type of element, e.g., button, lever, etc., can be used as long as the operative portion functions as desired.

Knife cartridge 110 comprises blade 111 and cartridge housing 112 which holds the blade in a fixed position relative to the housing. FIG. 1b shows a first position in which the knife cartridge is fully encased within the operative portion of the body as indicated by the dotted lines. FIG. 1c shows the knife cartridge in a second position in which the knife cartridge partially protrudes from the operative portion of the body with dotted lines indicating a portion of the knife cartridge that is encased within the operative portion. Hand tool 100 is designed to be used to open packaging when blade 111 is visible outside of the body, for example, as shown in FIG. 1b. FIG. 1d shows the knife cartridge in a third position in which the knife cartridge protrudes farther from the operative portion as compared to the knife cartridge in the second position. In some embodiments, the third position comprises a releasable and/or removeable position for the knife cartridge with respect to the body. After positioning the knife cartridge in the third position, a user can remove the knife cartridge from the body and replace it with a new knife cartridge.

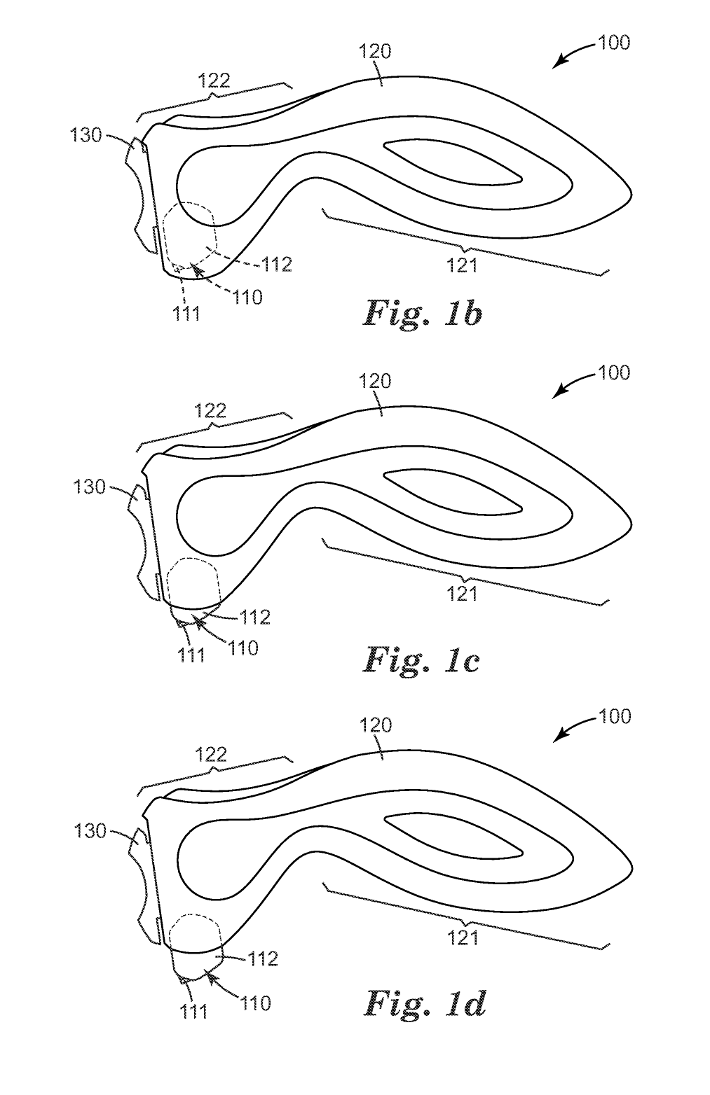

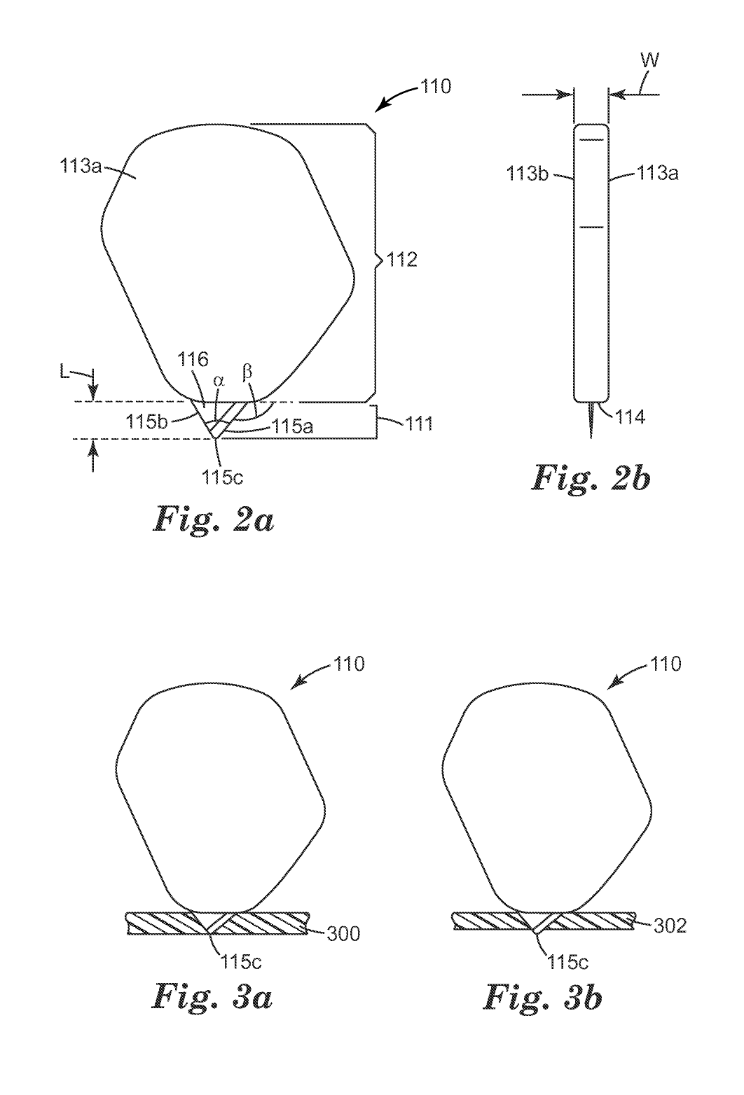

FIGS. 2a and 2b show side and edge views, respectfully, of exemplary knife cartridge 110. Cartridge housing 112 generally comprises two opposing sides such as 113a and 113b which are major surfaces of the housing. A plurality of edges define the perimeter of the cartridge housing. In general, the cartridge housing has three or more edges that define the perimeter of the cartridge housing, for example, cartridge housing 112 comprises six edges. The distance between the two opposing sides defines width, W, of the cartridge housing. At least one of the edges comprises a guide edge having a substantially planar surface, for example, cartridge housing 112 comprises guide edge 114.

Blade 111 partially protrudes from and is generally perpendicular to the planar surface of guide edge 114. The blade itself is planar and protrudes from the cartridge housing such that a blade tip and two or more edges, at least one edge comprising a cutting edge, can be utilized for cutting. The visible portion of the blade that protrudes from the cartridge housing defines a planar cutting area. As shown in FIG. 2a, blade 111 comprises cutting edge 115a, edge 115b which can comprise a second cutting edge, and blade tip 115c formed by the edges. Guide edge 114, cutting edge 115a, edge 115b and blade tip 115c define planar cutting area 116.

The cutting area of the blade and its relationship to the substantially planar surface of the guide edge of the cartridge housing is a characteristic of the hand tool that enables the average consumer to open plastic clamshell package with ease relative to known hand tools designed for cutting. The distance from guide edge 114 to blade tip 115c defines length, L, and this distance is long enough such that plastic sheeting used for clamshell packaging can be cut and short enough such that little or no portion of the cutting area extends through the thickness of the sheeting. FIGS. 3a and 3b show exemplary knife cartridge 110 used to open plastic sheeting 300 and 302, respectively, wherein plastic sheeting 300 is thicker than plastic sheeting 302. In FIG. 3a, blade tip 115c extends through the thickness of film 300 but not beyond the film, and in FIG. 3b, the blade tip extends through the thickness of film 302 such that this film is slightly punctured without damaging contents enclosed by the film. The distance from guide edge 114 to blade tip 115c can be any useful length, for example, anywhere from about 0.015 to about 0.375 inches, from about 0.015 to about 0.08 inches, from about 0.04 to about 0.08 inches, or from about 0.08 to about 0.375 inches.

Referring again to FIG. 2a, the cutting area of the blade can be characterized as having a blade angle, α, formed by the edges that define the blade tip. The blade angle can be any useful angle as long as the knife cartridge and hand tool can function as desired. For example, the blade angle may be within a particular range of angles such that the blade tip can facilitate penetration of the blade into the plastic sheeting. For example, the blade angle can be from about 20 to about 120 degrees, or from about 80 to about 100 degrees.

As shown in FIG. 2a, cutting area 116 of the blade is related to guide edge 114 according to cutting angle, β, formed by cutting edge 115a and the guide edge. The cutting angle can be any useful angle as long as the knife cartridge and hand tool can function as desired. For example, the cutting angle can be from about 30 to about 160 degrees, or from about 100 to about 160 degrees.

Returning to FIGS. 1a-1d, body 120 comprises an elongated housing typically formed by injection molding of a polymeric material. The particular choice of polymeric material is not particularly limited as long as the housing can be manufactured as desired and can function as desired once the tool is put together. The elongated housing may also be made by metal injection molding, die-casting, forming, machining and the like. The elongated housing may comprise more than one material as shown in FIG. 1a; a hard rigid polymer material may be used to form portion 120a of the elongated housing, and a soft polymeric material may be used to form portions 120b, as desired, for comfort when the hand tool is being gripped. The elongated housing can be an ergonomic elongated housing as shown in FIG. 1a.

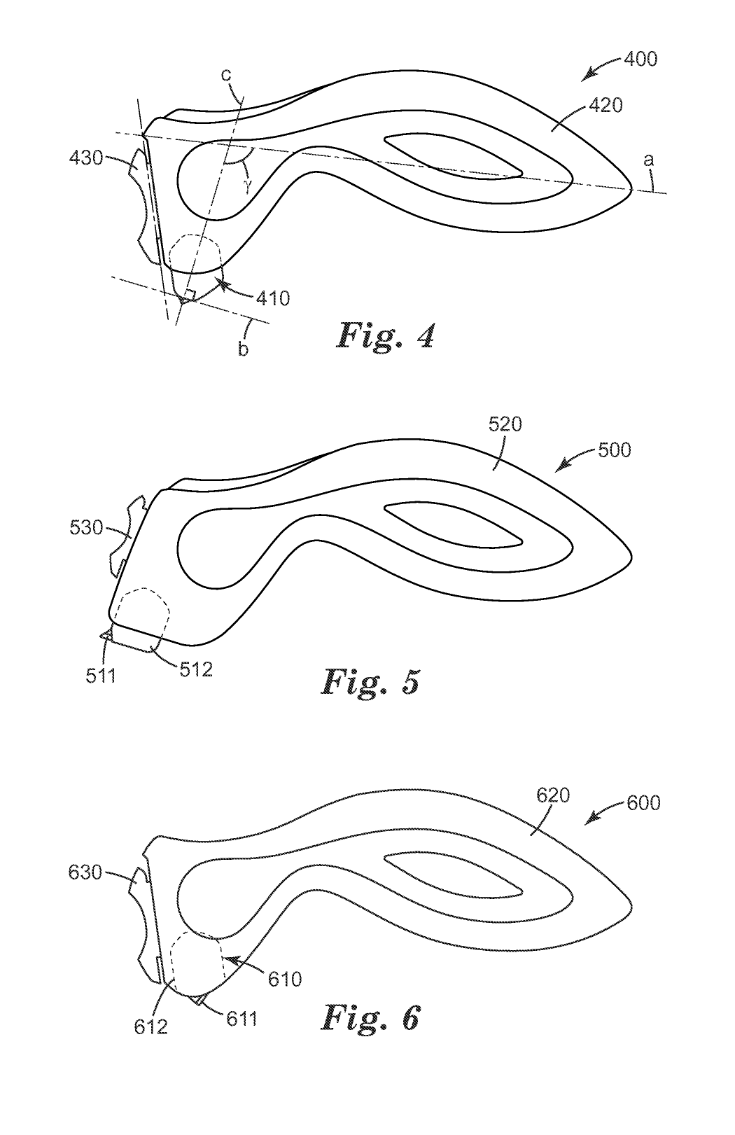

FIG. 4 shows a schematic side view of exemplary hand tool 400 comprising knife cartridge 410, body 420 and button 430. FIG. 4 illustrates an exemplary geometric relationship between the body and the guide edge of the knife cartridge. For hand tool 400 in side view: longitudinal axis, a, is defined by the longest distance between any two ends of body 420 without any portion of the longitudinal axis outside the perimeter of the body; guide edge axis, b, is defined by an axis parallel to the guide edge; and normal guide edge axis, c, is defined by an axis perpendicular to the guide edge axis. The longitudinal axis and the normal guide edge axis form guide angle, γ, which may be from about 30 to about 180 degrees, or from about 90 to about 120 degrees.

The hand tool may be designed such that any portion of the knife cartridge does not extend beyond the maximum length of the body; this embodiment is shown in FIGS. 1a-1d. In some embodiments, the hand tool may be designed such that a portion of the knife cartridges does extend beyond the maximum length of the body. For example, FIG. 5 shows a schematic side view of exemplary hand tool 500 comprising body 520, button 530 and a knife cartridge comprising blade 511 and cartridge housing 512. A portion of the knife cartridge extends beyond the maximum length of body 520. The hand tool may be designed such that the blade and a portion of the cartridge housing extend beyond the maximum length of body 520, or such that only the blade extends beyond the maximum length, and the cartridge housing does not.

In some embodiments, the knife cartridge is held in a fourth position which may define another position for the cartridge to engage in cutting. FIG. 6 shows a side view of exemplary hand tool 600 comprising body 620, button 630 and knife cartridge 610 in a fourth position. In this fourth position, the knife cartridge is partially encased within the operative portion such that only the blade with blade tip 611 protrudes from the body and cartridge housing 112 does not. In this forth position shown in FIG. 6, the body can be used as the guide edge.

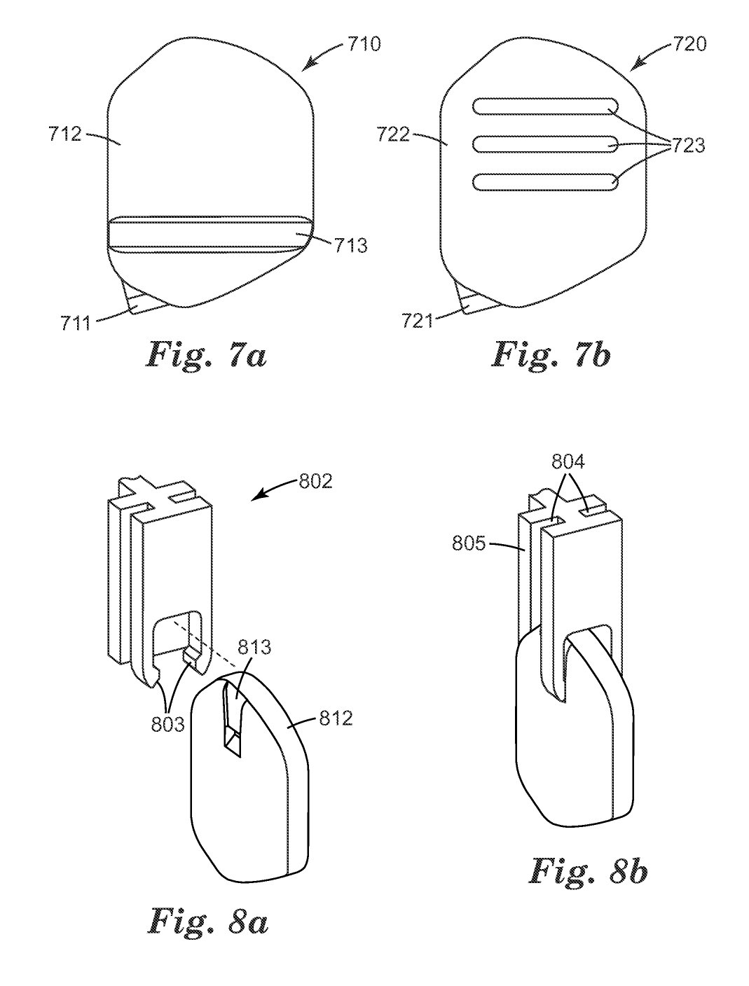

FIGS. 7a and 7b shown embodiments of the knife cartridge, particularly embodiments of the cartridge housing. In FIG. 7a, knife cartridge 710 comprises blade 711 and cartridge housing 712 that comprises feature 713 that engages or couples with the operative portion of the body. In FIG. 7b, knife cartridge 720 comprises blade 721 and cartridge housing 722 that comprises three features 723 that engage or couple with the operative portion for holding the knife cartridge in three different positions.

The knife cartridge and the operative portion of the body can engage or couple in any useful way as long as the hand tool can function as desired. Referring to FIGS. 8a and 8b, an embodiment is shown in which a portion of cartridge holder 802 having tabs 803 is shown, along with cartridge housing 812 having indentations 813 on opposing major surfaces (only one indentation is shown). FIG. 8b shows indentations 813 mated with tabs 803 such that the knife cartridge is held in a fixed position relative to the cartridge holder. The cartridge holder itself can be configured with grooves 804 and protrusions 805.

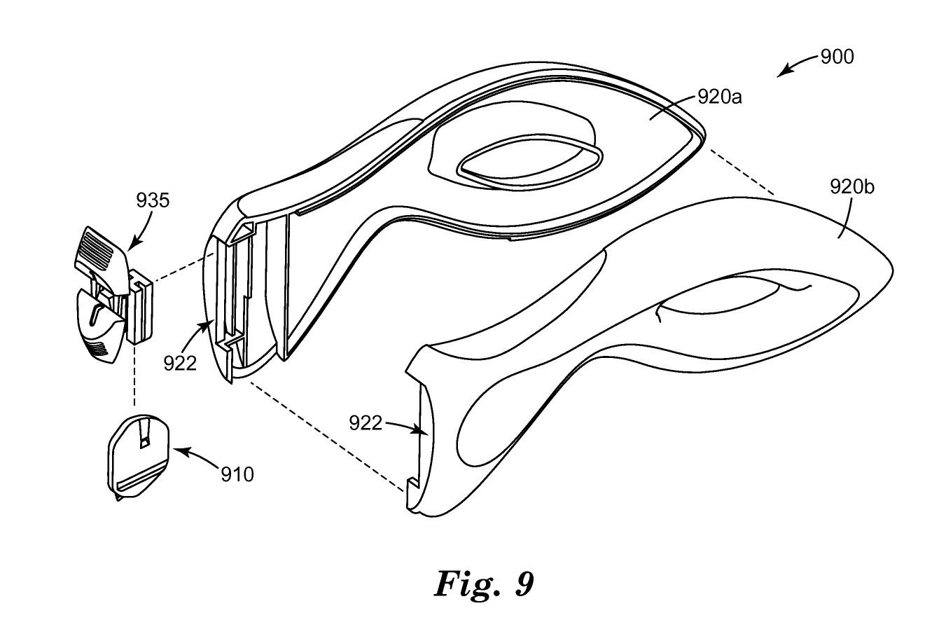

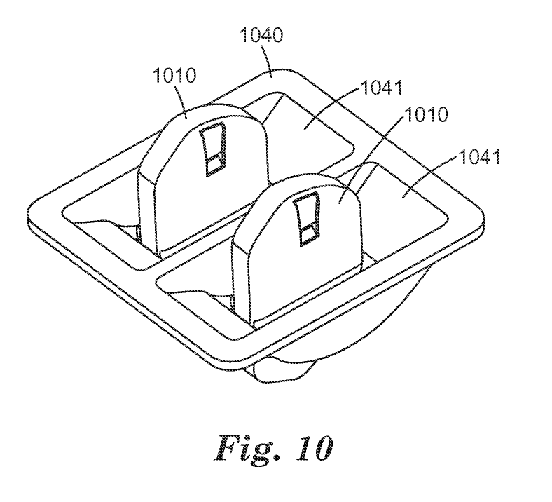

Referring to FIG. 9, exemplary hand tool 900 comprises knife cartridge 910, body 920 and a combination contoured button/cartridge holder 935. The cartridge housing of the knife cartridge comprises features on each side, the features comprising a single slot and indentations. The body is comprised of two separate parts 920a and 920b that mate together as shown by the dotted lines. The body includes operative portion 922 comprising multiple slots and grooves that engage with combination contoured button/cartridge holder 935. The multiple slots and grooves can be configured to hold the knife cartridge in the desired number of positions and optionally for releasing and/or removing the knife cartridge from the operative portion. For example, the multiple slots and grooves can be configured to hold the knife cartridge in the first and second positions as described for FIGS. 1b and 1c, and optionally the multiple slots and grooves can be configured to hold the knife cartridge in the third position as described for FIG. 1d.

In some embodiments in which the knife cartridge can be held in a third position, the hand tool is designed such that for the first, second and third positions, the blade is aligned along an axis. In some embodiments in which the knife cartridge can be held in a third position, the hand tool is designed such that for the first, second and third positions, the blade is aligned along a curve.

Although specific embodiments have been illustrated and described herein, alternative or additional embodiments can be envisioned by one of ordinary skill in the art without departing from the scope of the invention disclosed herein.

What is claimed is:

1. A hand tool comprising:
(a) a knife cartridge including a cartridge housing and a blade,
the cartridge housing having two opposing sides and a plurality of edges, at least one of the edges comprising a guide edge having a substantially planar surface, the cartridge housing holding the blade in a fixed position such that the blade partially protrudes from the guide edge,
(b) a body comprising
a grip portion, and
an operative portion configured to hold the knife cartridge in a first position in which the knife cartridge is fully encased within the operative portion, and a second position in which the knife cartridge is partially encased within the operative portion such that the cutting edge of the blade protrudes from the operative portion of the body, and the guide edge of the knife cartridge engages with a surface of an item being cut.

2. The hand tool of claim 1, the blade comprising a cutting edge and a second edge that form a blade tip, wherein the distance from the guide edge to the blade tip is from about 0.015 to about 0.375 inches.

3. The hand tool of claim 1, the blade comprising a cutting edge and a second edge that form a blade tip, wherein the distance from the guide edge to the blade tip is from about 0.015 to about 0.08 inches.

4. The hand tool of claim 1, the blade comprising a cutting edge and a second edge that form a blade tip, wherein the distance from the guide edge to the blade tip is from about 0.04 to about 0.08 inches.

5. The hand tool of claim 1, the blade comprising a cutting edge and a second edge that form a blade tip, wherein the distance from the guide edge to the blade tip is from about 0.08 to about 0.375 inches.

6. The hand tool of claim 1, the blade comprising a cutting edge and a second edge that form a blade tip, the blade tip having a blade angle from about 20 to about 120 degrees.

7. The hand tool of claim 1, the blade comprising a cutting edge and a second edge that form a blade tip, the blade tip having a blade angle from about 80 to about 100 degrees.

8. The hand tool of claim 1, the blade comprising a cutting edge, wherein a cutting angle formed between the cutting edge and guide edge is from about 30 to about 160 degrees.

9. The hand tool of claim 1, the blade comprising a cutting edge, wherein a cutting angle formed between the cutting edge and guide edge is from about 100 to about 160 degrees.

10. The hand tool of claim 1, for the hand tool in side view:
a longitudinal axis is defined by the longest distance between any two ends of the body without any portion of the longitudinal axis outside the perimeter of the body;
a guide edge axis is defined by an axis parallel to the guide edge; and
a normal guide edge axis is defined by an axis perpendicular to the guide edge axis,
wherein the longitudinal axis and the normal guide edge axis form a guide angle from about 30 to about 180 degrees.

11. The hand tool of claim 1, for the hand tool in side view:
a longitudinal axis is defined by the longest distance between any two ends of the body without any portion of the longitudinal axis outside the perimeter of the body;
a guide edge axis is defined by an axis parallel to the guide edge; and
a normal guide edge axis is defined by an axis perpendicular to the guide edge axis,
wherein the longitudinal axis and the normal guide edge axis form a guide angle from about 90 to about 120 degrees.

12. The hand tool of claim 1, the body having a maximum length, wherein the knife cartridge does not extend beyond the maximum length of the body.

13. The hand tool of claim 1, the body having a maximum length, wherein a portion of the knife cartridge extends beyond the maximum length of the body.

14. A hand tool of claim 1, wherein the operative portion is configured to hold the knife cartridge in a third position different from the first and second positions.

15. The hand tool of claim 14, wherein the knife cartridge is removable from the operative portion when in the third position.

16. A hand tool of claim 1, wherein the operative portion is configured to hold the knife cartridge in a fourth position wherein only the blade protrudes from the body.

17. The hand tool of claim 1, wherein at least one side of the cartridge housing comprises at least one feature that couples to the operative portion of the body such that the operative portion holds the knife cartridge in the first and second positions.

18. The hand tool of claim 1, further comprising a cartridge holder having tabs that mate with indentations on each side of the knife cartridge in the first and second positions.

19. The hand tool of claim 1, further comprising a button for positioning the knife cartridge in the first and second positions, and the button engages with the operative portion of the body by a sliding mechanism.

20. The hand tool of claim 1, further comprising a combination button/cartridge holder for positioning the knife cartridge in the first and second positions, the holder comprising a button and a cartridge holder, and the combination button/cartridge holder engages with the operative portion of the body by a sliding mechanism.
